(19) United States
(12) Patent Application Publication
(10) Pub. No.: US 2015/0013957 A1
(43) Pub. Date: Jan. 15, 2015

(54) Thermal Probe

(71) Applicant: Tasseron Sensors, Inc., Williamsport, PA (US)

(72) Inventor: Thomas J. Van Dijk, Williamsport, PA (US)

(73) Assignee: Tasseron Sensors, Inc., Williamsport, PA (US)

(21) Appl. No.: 14/498,059

(22) Filed: Sep. 26, 2014

Related U.S. Application Data
(63) Continuation of application No. 13/352,536, filed on Jan. 18, 2012.
(60) Provisional application No. 61/437,405, filed on Jan. 28, 2011.

(51) Int. Cl. F24F 11/00; G01K 7/22; G01K 7/16

(52) U.S. Cl. CPC F24F 11/0012; F24F 11/008; G01K 7/16; G01K 7/22; F24F 2011/0082
USPC 165/217; 374/185; 374/179

(57) ABSTRACT

A temperature probe having a terminal attachment arrangement for securing and selectively releasing an electrical connection is disclosed. The temperature probe further includes a housing for sealing the temperature probe to a structure, such as a HVAC duct.

### CROSS REFERENCE TO RELATED APPLICATIONS

This patent application is a continuation of U.S. Nonprovisional patent application Ser. No. 13/352,536 filed Jan. 18, 2012, which is incorporated by reference as if set forth in full herein. This application claims the benefit of U.S. Provisional Patent Application Ser. No. 61/437,405 filed on Jan. 28, 2011, and entitled “THERMAL PROBE”, the disclosure of which is hereby incorporated by reference herein in its entirety and made part of the present U.S. utility patent application for all purposes.

### FIELD OF THE INVENTION

The present invention relates generally to a probe apparatus. It relates more particularly to a thermal probe for HVAC applications having a releasable wire attachment device.

### BACKGROUND OF THE INVENTION

Temperature sensors typically include a sensing element that provides a signal to an electrical circuit. The sensing element may be a resistive temperature detector, a thermocouple, or a thermister, which changes electrical resistance based on temperature. As the electrical resistance of the sensing element changes, the electrical circuit can measure the electrical resistance and determine the corresponding temperature.

A temperature sensor is usually housed in a rigid probe housing, such as a metal tube or sheath, which may be supported by a housing or attachment structure. In the past, the temperature sensor has been attached to the electrical circuit by terminating circuit wires, cables or other electrical connections to the sensor by soldering or by using fasteners that require a tool. These attachment methods require operator time and may not provide consistent electrical connectivity.

In some applications, the probes are permanently installed in ductwork as part of the control system. Frequently, these heating, ventilation and air conditioning (HVAC) applications will include boilers for heating as well as compressor-driven systems for cooling. For boilers, the associated probe may be installed permanently. While the existing probes may be relocated or additional probes may be added to the ductwork, as noted above, the attachment methods are time consuming and may be subject to operator skill in making reliable electrical connections.

The present disclosure is directed to overcoming one or more of the problems set forth above.

### SUMMARY OF THE INVENTION

The present disclosure relates to a probe apparatus having an attachment device permits the probe to be attached quickly to a circuit to provide a secure circuit connection without the use of a tool or metal joining technique.

One advantage of the present disclosure is to provide a probe apparatus that can be connected to a circuit without the use of a tool or metal joining technique. The probe apparatus may be added to an existing circuit to provide a connection with better reliability than existing circuits. Alternatively, the probe apparatus of the present invention may be added to an HVAC system to replace existing temperature measuring instrumentation.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1A is a perspective view of a probe apparatus of the present invention. FIG. 1B is a rear View of the probe apparatus of FIG. 1A with the removable side removed. FIG. 1C is a top View of the bottom of the probe apparatus of FIG. 1A.

FIG. 2 is a perspective view of a different embodiment of the probe apparatus of the present invention having a different rear cover and attachment mechanism.

FIG. 3 is a perspective view of a different embodiment of the probe apparatus of the present invention.

FIG. 4 is a side view of another embodiment of the probe apparatus of the present invention.

FIG. 5 illustrates an embodiment of the invention in which the snap-fit rear cover has an arcuate shape.

FIG. 6 illustrate an embodiment of the probe apparatus in which the probe apparatus is strapped to the conduit.

Wherever possible, the same reference numbers will be used throughout the drawings to refer to the same or like parts.

### DETAILED DESCRIPTION OF THE INVENTION

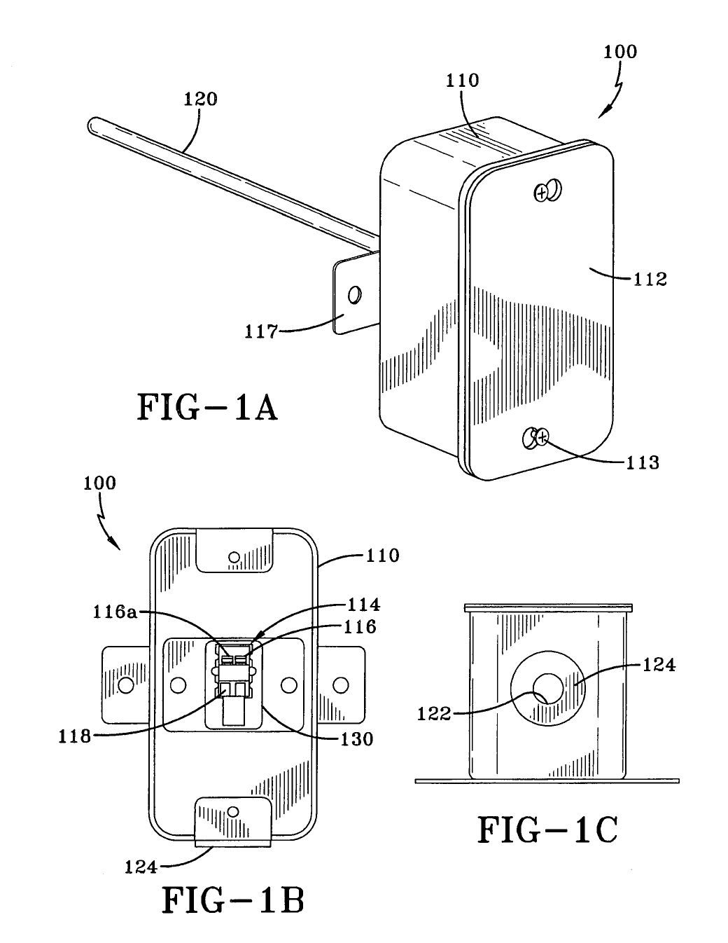

FIGS. 1-6 show various views of multiple embodiments of a probe apparatus according to the invention.

FIG. 1A illustrates an embodiment of a probe apparatus 100. The probe apparatus 100 includes a housing 110 and a sheath 120. The housing 110 includes a removable side 112. The removable side 112 is attached to the housing 110 by fasteners 113. The fasteners 113 that attach the removable side 112 to the housing include screws, bolts and nuts and the like. The fasteners, however, are not so limited and in other embodiments, may include latches, magnets or other fastening devices. The housing 110 further includes attachment portions 117, such as the flanges extending from housing 110, for attaching the probe apparatus to a structure (not shown), such as, but not limited to, a fluid duct, wall, joist, post, stud and the like (not shown).

The sheath 120 surrounds a sensor (not shown). The sensor may be a thermister, thermocouple, a resistive temperature sensor, or other device for measuring a fluid condition. In a preferred embodiment, the fluid is air, but the sensor may measure the condition of other fluids. It will be understood that the sensor may further include a wire that extends back from a tip or end of the sheath to terminal device 114. For example, the sensor may be an analog or digital device for measuring voltage, but is not so limited, and a wire or leads may extend as part of the sensor to the terminal device. The sensor itself preferably is a passive device that is not dependent upon application of power for performance of its function. The sheath 120 is connected to the housing 110 on a first side. For example, in one embodiment, the sheath is positioned so that the first side faces the fluid that is to be measured. The sheath thus could extend into an air duct to measure the temperature of the air flowing through the duct.

FIGS. 1B and 1C show a rear view and a View of the bottom (from above) of probe apparatus 100 of FIG. 1A, with the removable side 112 detached from housing 110 for viewing inner housing 130. As can be more readily seen in FIG. 1B, the probe apparatus 100 further includes a terminal device 114 received in inner housing 130 of apparatus 100. The terminal device 114 may be attached to inner housing 130 by a bonding material, such as, but not limited to epoxy and/or silicone based materials. Terminal device 114 is in electrical connectivity with the sensor positioned within sheath 120, and is so named as the electrical wires or leads of the sensor terminate at device 114. Terminal device 114 includes a release mechanism 116 for conveniently securing the wire or electrical leads to the terminal device 114. While any release mechanism 116 may be used, terminal device 114 depicted in FIG. 1B includes a quick release device such as lever 116a that can be operated by an operator to accept and release the electrical leads. Terminal device 114 further includes openings 118 for receiving and routing the electrical leads to the release mechanism 116. Lever may include a spring, the lever being biased by the spring so that the surfaces associated with the openings are maintained in a closed position when no force is applied to lever 116a. When an operator manually applies a force to counteract the spring force, thereby allowing the openings to be accessed by separating two surfaces, at least one being metal, a lead may be inserted into the opening. When the lever is released by the operator, the lever biases to a closed position, the lead or wire being captured between the surfaces as they capture the lead in the opening. In this exemplary embodiment, the terminal device 114 is configured to terminate two electrical leads. In another embodiment, the terminal device 114 may be configured to terminate one or more electrical leads.

As can be seen in FIGS. 1B and 1C, the housing 110 further includes an opening 122 for receiving the electrical leads into the housing 110. The housing 110 further includes a seal or web 124. The seal 124 may be a rubber grommet The seal 124 may be fluid tight or not.

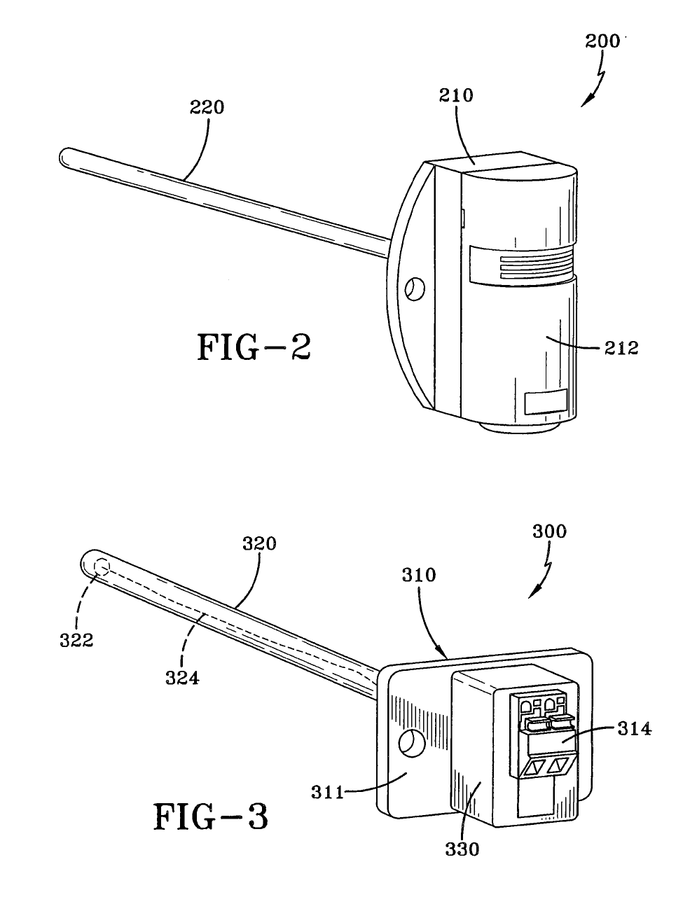

FIG. 2 illustrates another embodiment of probe apparatus 200 according to the invention. As can be seen in FIG. 2, probe apparatus 200 includes a housing 210 and a sheath 220. The housing 210 includes a rear cover 212. In this embodiment, the rear cover 212 is snap-cover that may be attached and released by an operator using an amount of force. Preferably, no tools are required to remove snap-cover 212 from probe housing 210. The sheath 220 and the internal components including the terminal device are similar to those used in the embodiment shown in FIGS. 1A, 1B and 1C.

FIG. 3 illustrates another embodiment of a probe apparatus 300 according to the invention. As can be seen in FIG. 3, probe apparatus 300 includes a housing 310 and a sheath 320. Sheath 320 contains temperature sensor 322, as discussed above. Housing 310 includes a first wall 311 for attaching the probe apparatus 300 to a structure, such as a duct, pipe, tube or other type of conduit. Sheath 320 extends away from the structure so that the sheath that contains the sensor can extend into the fluid that is to be measured. Leads or wire 324 extend from sensor 322 and are connected to terminal device 314, placing sensor 322 in electrical communication with terminal device 314. As can be seen in FIG. 3, the terminal device 314 is received in an inner housing of probe apparatus 300, and is retained therewithin by a bonding material, such as an epoxy or silicone based material.

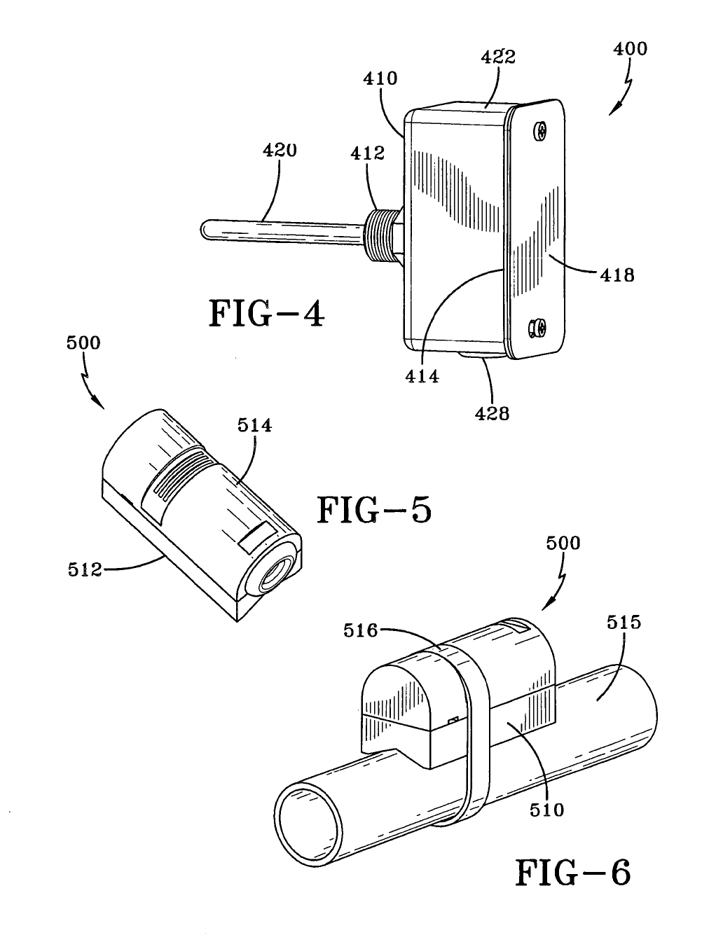

FIG. 4 illustrates a side view of another embodiment of a probe apparatus 400 according to the invention. As can be seen in FIG. 4, the probe apparatus 400 includes a housing 410 and an external thermal well 420 extending away from housing 410. Thermal well 420 contains a temperature probe that is used to measure the temperature of fluid flow in a volume into which the thermal well is extended. Housing 410 includes a first fastener 412 for attaching the probe apparatus 400 to a structure such as, but not limited to a fluid duct. The first fastener 412 is configured to provide a fluid tight seal between thermal well 420, the housing, and the interior of the housing. The housing 410 further includes a rear seal 414 for providing a fluid tight seal between a rear wall 418 and the housing body 422. The housing 410 further includes a bottom opening and seal 428 for proving a fluid tight opening for receiving electrical terminals into the interior of housing 410. The structure that receives thermal well 420 has a thread that mates with the thread of first fastener 412 so that thermal well 420 can be screwed into the structure. First fastener is not restricted to the embodiment depicted in FIG. 4. For example, first fastener 412 may be formed as a female threaded aperture in a face 432 of housing 410 from which sheath extends. In this circumstance, the structure may be fitted with a male aperture having threads mated to the female aperture in the structure. The probe apparatus can be secured to the structure by simply fastening the female aperture to the male aperture. In still another variation, thermal well 420 may be extended into a structure until face 432 of housing 410 abuts the face of the structure. A nut can be threaded onto first fastener 412 until housing is secured to the structure. In this embodiment, the threads of first fastener must extend into the inner housing (not shown in FIG. 4), so that nut can be attached to first fastener 412, whether the threads are formed as shown in FIG. 4 or whether the male threads are on a fastener extending from the structure. In any of these embodiments, if leakage of fluid around the threads is a concern, any readily available thread sealant compound may be applied to the threads of fastener 412.

As shown in FIG. 4, a bottom opening and seal 428 provides access to inner housing 434 for wires from a controller or thermostat so that a circuit may be completed from the temperature probe within thermal well 420 to the controller or thermostat. The controller controls a device, such as HVAC equipment that cools or heats fluid, air, flowing to a zone, space or room through the duct or conduit that is monitored by the sensor in sheath 120. Referring again to FIG. 1B or FIG. 3, the wires to the controller may be mated to the sensor leads (or leads of thermal probe—FIG. 4) or wires within attachment/release mechanisms 116 on terminal device 114. In a slightly more complicated embodiment, terminal device 114 may be a circuit board that includes separate attachment/release mechanisms 116 for the sensor leads and attachment/separate release mechanisms for the wires from the controller or thermostat. The circuit board may include internal connections, circuit traces, between the attachment/release mechanisms for the sensor leads and the attachment/release mechanisms for the controller/thermostat lead wires.

The probe apparatus of the present invention enables accurate temperature sensors to be installed in the field. Furthermore, the probe apparatus can be quickly and accurately installed or replaced. They may be removed or simply inactivated by disconnecting them, if so desired, unlike permanent probes installed in ductwork that physically forms part of the control. The sensors utilized with the probe are significantly more accurate than many of the permanently installed probes, the sensors of the present invention having am accuracy of i 0.2° F., as compared to some permanently installed probes having an accuracy of: 1:2° F. The probe apparatus of the present invention can readily be installed to measure temperature at virtually any location, from home applications to commercial applications such as malls or grocery stores. Typically, when modifications are made to structures, whether an addition is added to a home or renovations are made at a mall, air flow usually is affected. Further, in many circumstances, heating and cooling requirements are satisfied by sophisticated controllers that meet heating and cooling demands. It is important to obtain accurate temperature readings so that these heating and cooling demands can be properly met, since inaccurate readings can lead to an area being improperly heated or cooled, or both. Small variations in temperature measurement can result in a controller directing large volumes of conditioned air to an area or zone, so accurate readings are imperative. In many cases, controllers also have an advantage over thermostats in that they can be reprogrammed to meet changing conditions. Particularly in such circumstances, the probe apparatus of the present invention is very advantageous when used with such controllers, as the probe apparatus can be quickly installed and connected to controllers to monitor conditions in a new zone or area or even an existing but modified area. Thus, probe apparatus 100 of the present invention can be an energy savings device by preventing energy from being wasted by improperly heating or cooling a zone or an area. Although the probe apparatus has been discussed in terms of measuring the temperature of fluid flowing within a duct, the probe apparatus of the present invention can be installed anywhere, such as along a wall or partition of a zone, space or room to monitor the temperature of the room and communicate the temperature to the controller.

FIG. 5 and FIG. 6 illustrate another embodiment of a probe apparatus 500 according to the invention. As can be seen in FIG. 5 and FIG. 6, the probe apparatus 500 includes a housing 510. The housing 510 includes a housing body 512 having a rear cover 514. The rear cover 514 is a snap-fit cover. In this exemplary embodiment, the housing 510 includes a first side that houses a sensor. The sensor is electrically connected to a terminal device (not shown) contained within the housing, and the terminal device is connected to a controller.

As can be seen in FIG. 6, the probe apparatus 500 may be attached to a structure 515 by a fastening device 516. The structure 515 is a pipe; however, the structure is not so limited. Housing 510, housing body 512 and cover are molded to a shape that complements that of the structure. Here, an inner surface of housing body 512 has a radius that corresponds to the outer radius of the pipe, so that the surfaces mate. In this exemplary embodiment, the fastening device 516 is a band or strap. In another embodiment, the fastening device 516 may be a band, strap, wire, clamp or other retaining device. Other means of fastening may be used. For example, housing 510 may be attached to the structure using a permanent or semi-permanent polymer such as RTV, epoxy or other similar material. Also, when stresses in the fluid boundary are not a concern, it may be acceptable to attach the probe apparatus 500 to the structure with screws. The specific method of attachment of probe apparatus 500 to the structure, while important for proper use of the present invention, is not a fundamental part of the present invention.

The terminal device for probe apparatus 500 is connected to the sensor and the controller as previously described. In this circumstance, the terminal device also can be molded into a shape that corresponds to the shape of the structure. The terminal device and probe apparatus 500 can be molded into virtually any shape for application and attachment to any structure. Furthermore, the terminal device, housing 510 and rear cover 514 may be molded of pliable or rigid material, if desired. The sensor may be inserted through the structure, here a pipe, to directly measure the temperature of the fluid flowing through the pipe, in which case the sheath also will extend through the pipe, with suitable sealants used to prevent leakage of fluid through the pipe. Alternatively, the sensor may be mounted directly to the surface of the pipe to measure the surface temperature of the pipe. In this circumstance, housing 510 and housing body may include suitable insulation to substantially isolate the sensor from the temperature effects of the environment surrounding the exterior of the pipe and housing. The controller, using a suitable algorithm, can determine the temperature of the fluid flowing within the pipe, when the pipe material and pipe thickness is known. In many circumstances, measurement of the surface temperature of the pipe and use of a suitable algorithm will provide a temperature measurement that is suitable for use in an application. However, in those circumstances in which even minor changes in temperature require immediate response, a direct measurement by inserting the sensor (and sheath) into the conduit to directly measure the temperature of the fluid may be the preferred arrangement of measuring temperature.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A probe apparatus, comprising:
a sensor, the sensor including an electrical lead;
a housing;
an attachment portion secured to the housing; and
a terminal device positioned within the housing for securing the electrical lead from the sensor, wherein the terminal device is opened to receive the electrical lead by manually operating a lever, the lever configured to secure the electrical leads when released.

2. The probe apparatus of claim 1 further including: a sheath surrounding the sensor, the sheath extending from the housing, the electrical leads from the sensor extending through the sheath from the housing to the sensor.

3. The probe apparatus of claim 1 further including: an attachment structure and attachment portions connecting the housing to the attachment structure.

4. The probe apparatus system of claim 1 wherein the sensor is selected from the group consisting of a thermister, a thermocouple and a resistive temperature sensor.

5. The probe apparatus system of claim 1, the housing further including: a removable side, wherein the removable side provides access to the housing interior when removed.

6. The probe apparatus of claim 5 wherein the removable side is secured to the housing with at least one fastener.

7. The probe apparatus of claim 5 wherein the removable side is snap-fit to the housing.

8. The probe apparatus of claim 1 wherein the lever includes a spring, a preselected force manually applied to the lever overcoming the spring bias to separate mating surfaces of the terminal device to an open position to provide an opening for an electrical lead, and to a closed position to close the surfaces around the lead to capture the lead when the force is removed.

9. A temperature probe for monitoring the temperature of fluid flowing in a conduit, comprising:
a conduit;
a probe apparatus further comprising
a sensor, the sensor including an electrical lead,
a housing,
an attachment portion secured to the housing, and
a terminal device positioned within the housing for securing the electrical lead from the sensor, wherein the terminal device is opened to receive the electrical lead by manually operating a lever, the lever configured to secure the electrical leads when released; and
a structure, wherein the probe apparatus is attached to the structure using the attachment portion of the probe apparatus using fasteners, wherein the sensor extends from the probe into the conduit to measure the temperature of a fluid flowing within the conduit.

10. The temperature probe of claim 9 wherein the conduit has a preselected shape and the probe apparatus is molded to a shape that corresponds to the shape of the structure so that the probe apparatus can be mounted to the structure.

11. The temperature probe of claim 10 wherein the probe is secured to the conduit with a fastening device.

12. The temperature probe of claim 10 wherein the probe is secured to the conduit with a polymer.

13. The temperature probe of claim 10 wherein the sensor is in contact with a fluid flowing through the conduit.

14. The temperature probe of claim 10 wherein the sensor is affixed to an external surface of the conduit and directly monitors the surface temperature of the conduit.

15. A system for controlling temperature within a zone, comprising:
an HVAC system for conditioning air by cooling and heating;
a conduit for moving the conditioned air to the zone;
a temperature probe for monitoring the temperature of air provided to the zone, the temperature probe further comprising
a sensor, the sensor including an electrical lead,
a housing,
an attachment portion secured to the housing, and a terminal device positioned within the housing for securing the electrical lead from the sensor, and wherein the terminal device is opened to receive the electrical lead by manually operating a lever, the lever configured to secure the electrical leads when released;
a controller for controlling the conditioning of the air by the HVAC system, the controller in communication with the sensor and responsive to a signal from the sensor indicative of the temperature of air in the zone, the controller operative to adjust the flow and temperature of the air in the zone in accordance with a preselected algorithm to maintain the temperature of the zone within a predetermined range.

16. The system of claim 15 wherein the lever of the terminal device of the temperature probe includes a spring configured to apply a spring bias, a preselected force manually applied to the lever overcoming the spring bias to separate mating surfaces of the terminal device to an open position to provide an opening for an electrical lead, the spring bias moving the separate mating surfaces to a closed position to close the surfaces around the lead to capture the lead when the force is removed.

17. The system of claim 16 wherein the sensor extends from the probe into the conduit to measure the temperature of a fluid flowing within the conduit and into the zone.

18. The system of claim 16 wherein the sensor is mounted to the surface of the conduit to measure the temperature of the conduit.

19. The system of claim 16 wherein the sensor is mounted within the zone to measure the temperature of the zone.

20. The system of claim 16 wherein the controller includes leads secured to the terminal device within the housing, thereby providing communication with the sensor.
